(19) United States
(12) Patent Application Publication
(10) Pub. No.: US 2010/0192314 A1
(43) Pub. Date: Aug. 5, 2010

(54) HANDY CLEANERS

(75) Inventors: Hiroshi OTSUKA, Anjo-shi (JP); Hitoshi SUZUKI, Anjo-shi (JP); Shinsuke OKUDA, Anjo-shi (JP)

Correspondence Address: OLIFF & BERRIDGE, PLC, P.O. BOX 320850, ALEXANDRIA, VA, 22320-4850, US

(73) Assignee: MAKITA CORPORATION, Anjo-shi (JP)

(21) Appl. No.: 12/693,730

(22) Filed: Jan. 26, 2010

(30) Foreign Application Priority Data
Feb. 3, 2009 (JP) 2009-022382
Feb. 27, 2009 (JP) 2009-045782
Mar. 2, 2009 (JP) 2009-048246

(51) Int. Cl. B08B 7/00

(52) U.S. Cl. 15/3

(57) ABSTRACT

One aspect according to the present invention includes a handy cleaner including a cleaner body and a battery pack. The battery pack serves as a power source and includes a lithium-ion battery. The battery pack can be mounted to and removed from a cleaner body without need of operating a cover or the like mounted to the cleaner body.

This application claims priority to Japanese patent application serial numbers 2009-022382, 2009-045782, and 2009-048246, the contents of which are incorporated herein by reference.

### BACKGROUND OF THE INVENTION

1. Field of the Invention

The present invention relates to handy cleansers that can be held by a hand of a user during use.

2. Description of the Related Art

Handy cleaners utilizing DC motors as drive devices are known. As a power source of a DC motor, a battery pack repeatedly usable through recharging has been used. Techniques relating to battery packs of handy cleaners are disclosed, for example, in Japanese Laid-Open Utility Model Publication No. 61-198646, Japanese Laid-Open Patent Publication No. 63-240815 and Japanese Laid-Open Patent Publication No. 63-296721.

In the above publications, the battery pack can be mounted and removed via a battery removing opening provided in the rear portion of a body housing. When mounted after being inserted through the battery removing opening, the battery pack is electrically connected to a power source circuit of the body housing. In this mounted state, the battery pack is assembled within the body housing as a built-in component like a driving motor, a circuit board, etc. The battery removing opening is closed by a cover, and the battery pack in the mounted state is not visible from the outside.

The battery pack can be repeatedly used by removing it from the body housing with its cover detached, and by recharging it using a charger that is separately provided.

When the removing opening is closed by the cover, the battery pack assembled within the body housing is invisible, and, in order to remove the battery pack for the purpose of recharging or the like, it is necessary to detach the cover. The operations of opening and closing the cover are troublesome and there is a fear of the detached cover getting lost. Further, since it is necessary to assemble the battery pack within the body housing, it is rather difficult to achieve reduction in the size of the handy cleaner.

The battery packs have been used not only in handy cleaners but also in many other electric tools, such as an electric drill. In recent years, as batteries of the battery packs of electric tools, in addition to nickel-cadmium batteries, lithium ion batteries that may be lighter in weight than nickel-cadmium batteries have been used.

On the other hand, a circular saw using a battery pack as a power source is known. The battery pack is not assembled within a body housing of the circular saw but can be detachably mounted to a front end of a handle of the circular saw.

There is a need in the art for a further improved handy cleaner.

### SUMMARY OF THE INVENTION

One aspect according to the present invention includes a handy cleaner including a cleaner body and a battery pack. The battery pack serves as a power source and includes a lithium-ion battery. The battery pack can be mounted to and removed from a cleaner body without need of operating a cover or the like mounted to the cleaner body.

### BRIEF DESCRIPTION OF THE DRAWINGS

FIG. 1 is a side view of an entire handy cleaner according to a first embodiment of the present invention with a battery pack attached thereto;

FIG. 2 is a side view similar to FIG. 1 but showing the internal structure of a rear portion of the handy cleaner;

FIG. 3 is a side view similar to FIG. 1 but showing the state where the battery pack has been removed;

FIG. 4 is a bottom view, as viewed from a direction indicated by arrow (IV) in FIG. 3, of a battery pack mounting portion;

FIG. 5 is a perspective view of the battery pack;

FIG. 6 is a side view of an entire handy cleaner according to a second embodiment of the present invention;

FIG. 7 is a side view similar to FIG. 6 but showing the internal structure of a rear portion of the handy cleaner;

FIG. 8 is a side view similar to FIG. 6 but showing the state where the battery pack has been removed;

FIG. 9 is a rear view, as viewed from a direction indicated by arrow (IX) in FIG. 8, of a battery pack mounting portion;

FIG. 10 is a side view of an entire handy cleaner according to a third embodiment of the present invention with a battery pack attached thereto;

FIG. 11 is a side view similar to FIG. 10 but shown the state where the battery pack has been removed;

FIG. 12 is a perspective view of the battery pack of the third embodiment;

FIG. 13 is a rear view, as viewed from a direction indicated by arrow (XIII) in FIG. 11, of a battery pick mounting portion;

FIG. 14 is a perspective view of a handy cleaner according to a fourth embodiment of the present invention;

FIG. 15 is a left side view, as viewed from a direction indicated by arrow (XV) in FIG. 14, of the handy cleaner of the fourth embodiment, with the right hand of the user grasping the handle being indicated by chain double-dashed lines;

FIG. 16 is a right side view, as viewed from a direction indicated by arrow (XVI) in FIG. 14, of the handy cleaner of the fourth embodiment;

FIG. 17 is a plan view, as viewed from a direction indicated by arrow (XVII) in FIG. 14, of the handy cleaner of the fourth embodiment;

FIG. 18 is a side view of the entire handy cleaner of the fourth embodiment and showing the state where the battery pack has been removed;

FIG. 19 is a bottom view, as viewed from a direction indicated by arrow (XIX) in FIG. 18, of a battery mounting portion;

FIG. 20 is a perspective view of the battery pack; and

FIG. 21 is an enlarged view of a handle.

### DETAILED DESCRIPTION OF TEE INVENTION

Each of the additional features and teachings disclosed above and below may be utilized separately or in conjunction with other features and teachings to provide improved handy cleaners. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

In one embodiment, a handy cleaner includes a cleaner body and a battery pack. The cleaner body includes a handle capable of being grasped by a user during use of the handy cleaner. The battery pack serves as a power source and includes a lithium-ion battery. The battery pack has an engaging device and a releasing device. The engaging device is capable of engaging the cleaner body when the battery pack is positioned at a mounting position relative to the cleaner body. The releasing device is coupled to the engaging device and is operable to release engagement of the engaging device with the cleaner body.

With this construction, the battery pack can be mounted to and removed from the cleaner body without need of operating a cover or the like. Therefore, it is possible to easily perform the mounting and removing operations of the battery pack. In addition, it is possible to configure the battery pack to be shared by different handy cleaners or other power tools.

The engaging device may include an engaging claw provided on the battery pack, and the releasing device may include a release button movably attached to the battery pack. The engaging claw is capable of being engaged with and disengaged from the cleaner body. The release button is operable to move the engaging claw for disengagement from the cleaner body.

With this arrangement, it is possible to reliably mount the battery pack to the cleaner body. In addition, it is possible to remove the battery pack by a simple operation of the release button. Therefore, the handling property of the handy cleaner can be improved.

The handle may be disposed at a rear portion of the cleaner body and the battery pack may be attached to the handle so as to extend along a lower portion of the handle. With this arrangement, because the battery pack is positioned on the lower side of the handle, it is possible to improve a weigh balance of the handy cleaner when the operator uses the handy cleaner or carries about the handy cleaner. Therefore, the operability of the handy cleaner can be improved.

The lower portion of the handle may include a pair of guide rails. The battery pack can be slid along the pair of guide rails to move to the mounting position and to move away from the mounting position. Therefore it is possible to easily mount and remove the battery pack.

A space allowing insertion of a finger of a user may be provided between the cleaner body and a front portion of the battery pack in the mounting position. This arrangement may facilitate the removing operation of the battery pack.

In another embodiment, when the battery pack is mounted to the cleaner body, at least a part of an outer surface of the battery pack is directly exposed to the outside of the cleaner body; and the at least a part of the outer surface can be grasped by a hand of a user for removing the battery pack from the cleaner body.

In a further embodiment, the cleaner body includes a loop-shaped handle capable of being grasped by a user, and a cover is attached to the handle and made of elastomer resin.

In a still further embodiment, an upper portion of the handle has an upper surface configured as an arc-shaped surface gently curved in forward and rearward directions to correspond to the configuration of a palm of a hand of a user who grasps the handle. The handle has a thickness gradually decreasing from a front portion toward a rear portion. A rear end portion of the inner circumference of the handle has a little finger holding portion. The little finger holding portion has a semi-circular arc-shaped configuration corresponding to the configuration of a base portion of a little finger of a hand of a user who grasps the handle.

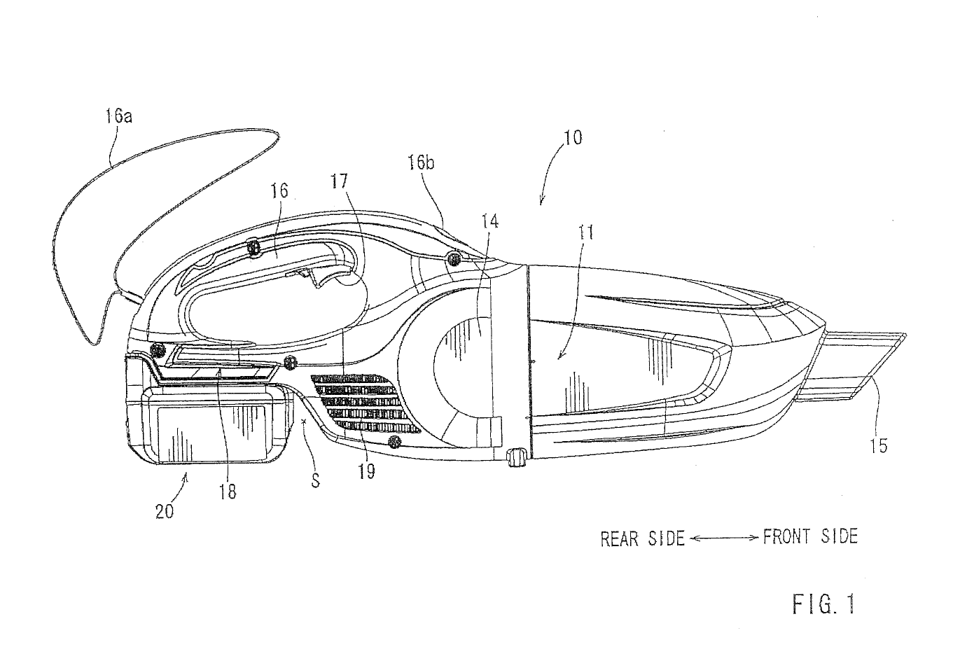

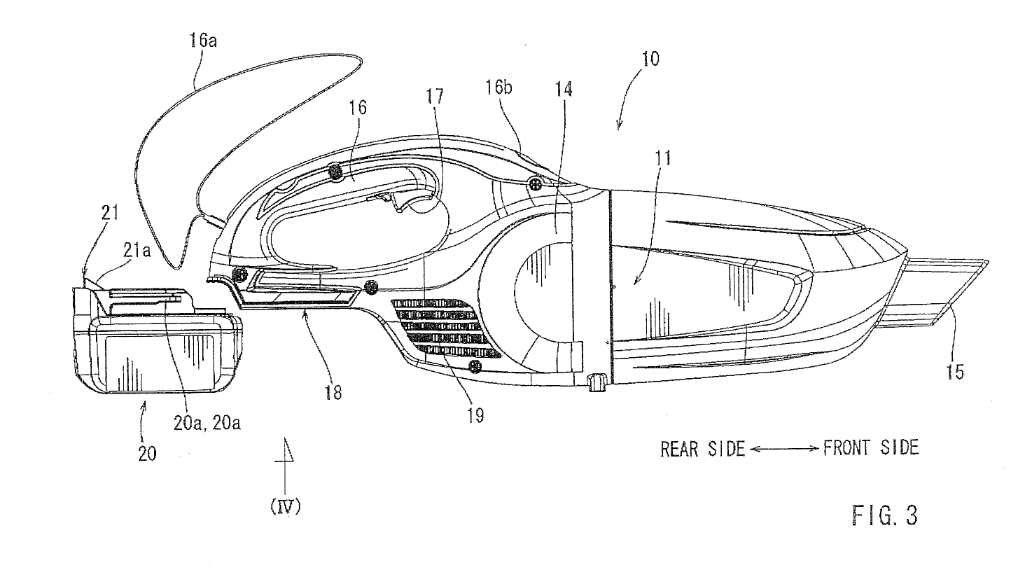

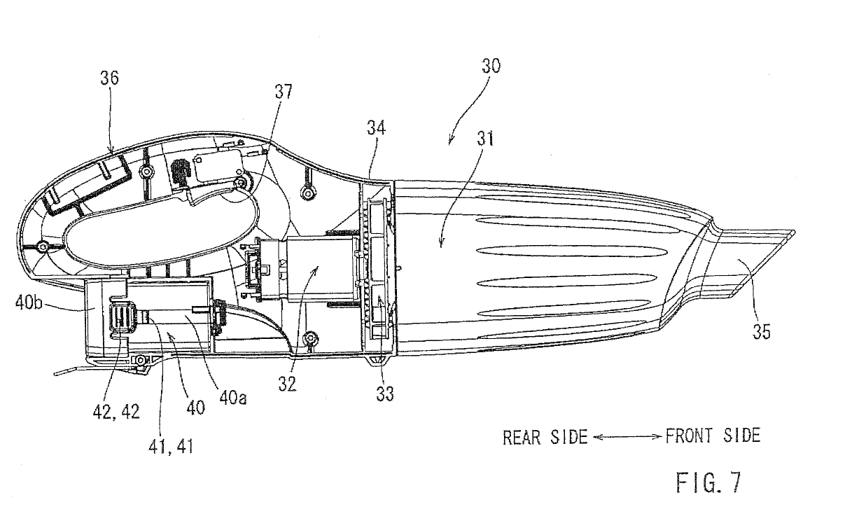

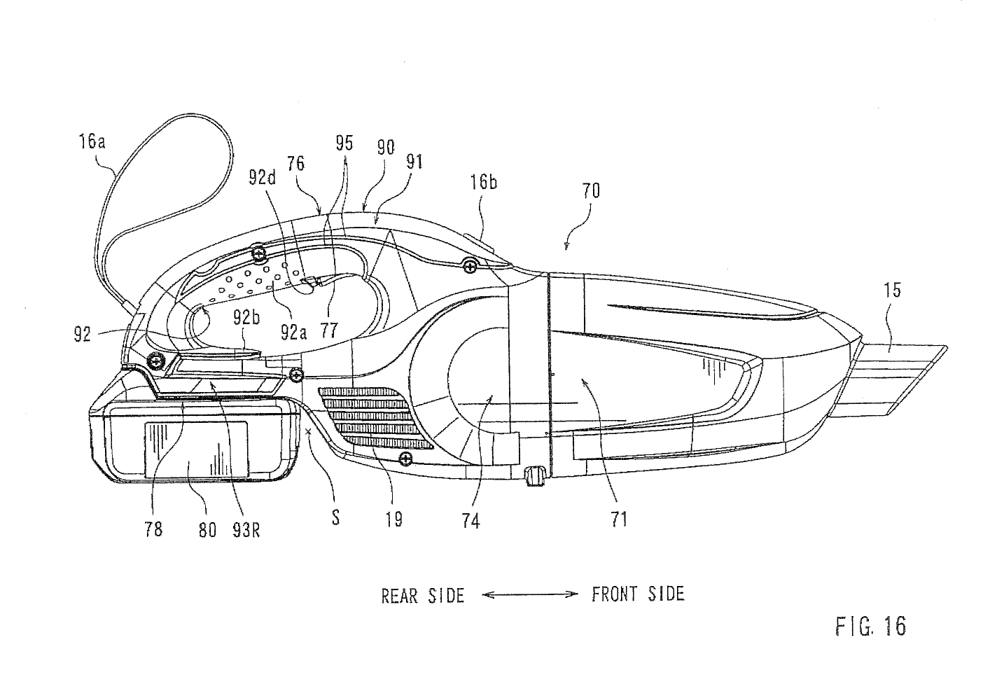

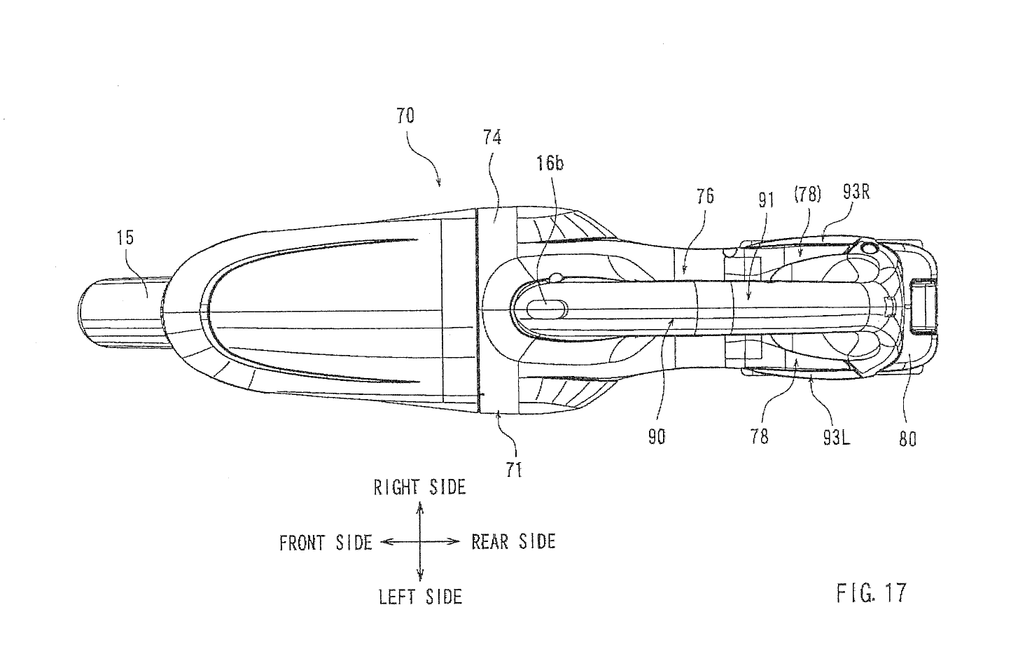

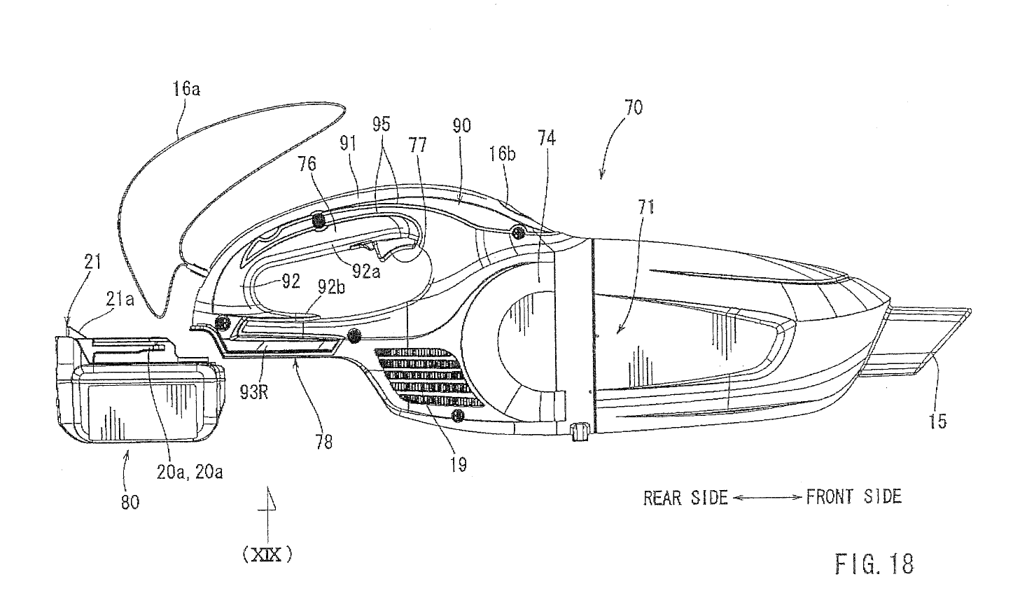

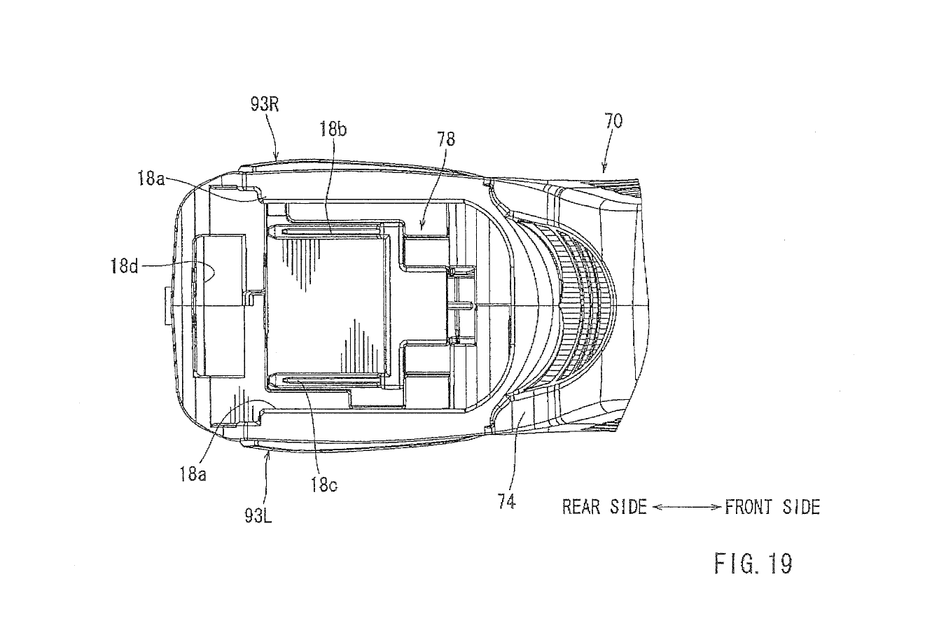

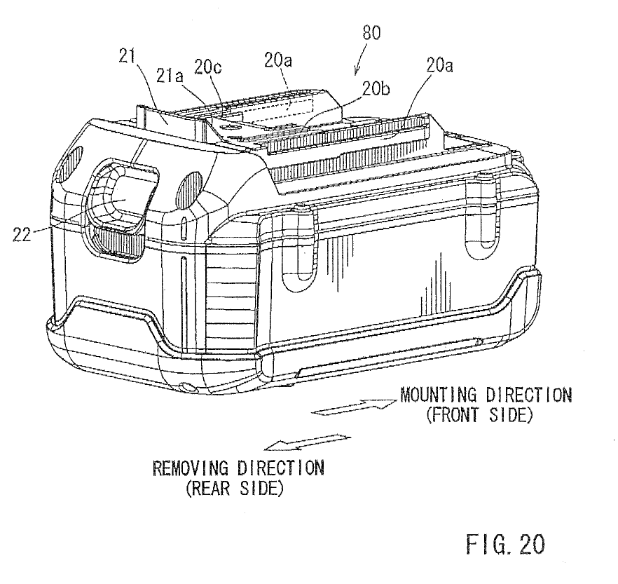

Next, first to fourth embodiments of the present invention will now be described with reference to FIGS. 1 through 21. Handy cleaners 10, 30, 50, and 70 according to these embodiments are configured as small and lightweight rechargeable cleaners that can be easily held with one hand of a user, for example, for cleaning the interior of a cabin of an automobile or for cleaning a narrow room. These cleaners have battery packs 20, 30, 60, and 80 attached to cleaner bodies 11, 31, 51, and 71, respectively.

### First Embodiment

FIGS. 1 through 3 show the handy cleaner 10 of the first embodiment. The handy cleaner 10 has the battery pack 20 as a power source, which can be repeatedly used by being removed from the cleaner body 11 and recharged. The cleaner body 11 has a body housing 14, in which an electric motor 12 and a suction mechanism 13 are accommodated. The electric motor 12 is driven by an electric power supplied from the battery pack 20. The suction mechanism 13 primarily includes a fan rotatably driven by the electric motor 12. A dust inlet port 15 is provided at the front end portion of the body housing 14. The front half of the body housing 14 can be removed from the rear half for the purpose of disposing of the collected dust.

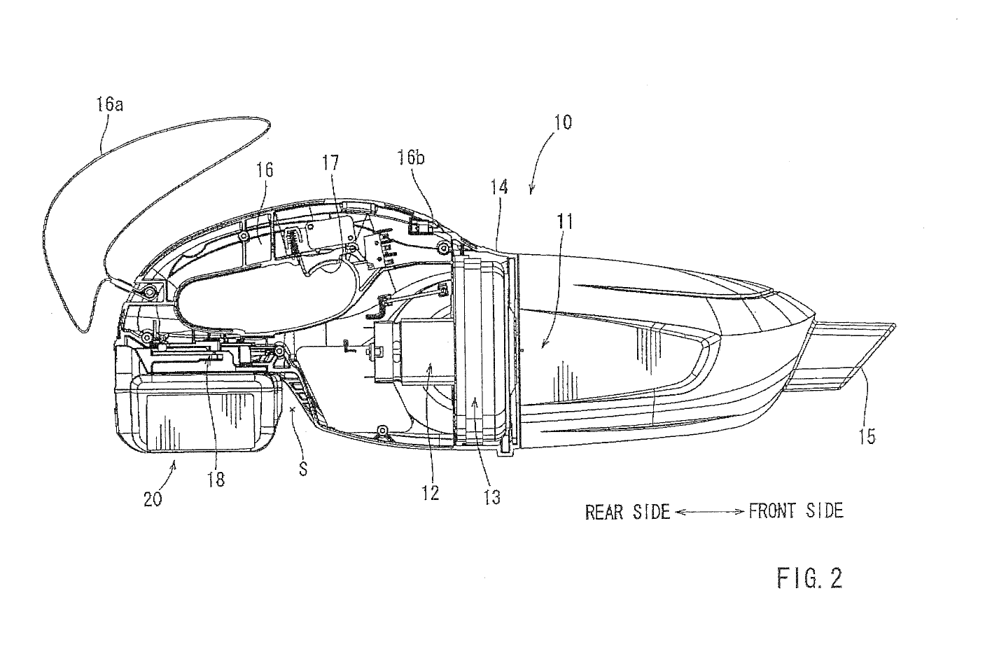

At the rear portion of the body housing 14, there is provided a loop-shaped handle 16 that can be grasped by the user. On the inner peripheral side of the handle 16, there is provided a switch lever 17 that can be pulled by a finger of the user. When the switch lever 17 is pulled upwards, the electric motor 12 is started, so that dust or the like can be drawn from the dust inlet port 15. A suspension strap 16a is attached to the rear portion of the handle 16, and a light 16b conveniently used when cleaning in a dark place is provided on the front portion of the handle 16. As shown in FIG. 2, the light 16b is disposed within the front portion of the handle 16, where there is no obstacle in front of the front portion, and the light 16b does not protrude from a front surface of the front portion. The light 16b can brightly illuminate mainly a portion around the dust inlet port 15. As the light source of the light 16b, there is employed an LED (light emitting diode). It is also possible to employ an electric bulb instead of an LED. The battery pack 20 is used also as the power source of the light 16b.

On the lower side of the handle 16, there is provided a battery mounting portion 18, to which the battery pack 20 can be attached. An exhaust port 19 is provided on the front side of the battery mounting portion 18.

The battery pack 20 can be mounted to the battery mounting portion 18 by slidably moving forwardly relative thereto. Conversely, the battery pack 20 can be removed from the battery mounting portion 18 by slidably moving rearwardly relative thereto.

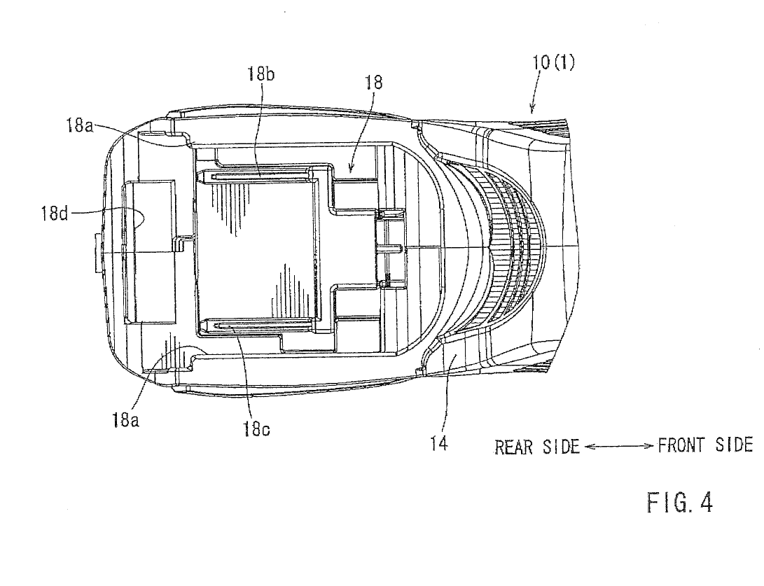

FIG. 4 shows the battery mounting portion 18 in detail. A pair of right and left guide rail portions 18a are provided integrally with the right and left sides of the battery mounting portion 18. In correspondence with the right and left guide rail portions 18a, a pair of right and left engaging protrusions 20a are integrally provided with the right and left side portions of the upper side of the battery pack 20. Slidably moving the battery pack 20 in forward and rearward directions relative to the battery mounting portion 18 can cause engagement and disengagement of the right and left guide rail portions 18a with and from the engaging protrusions 20a, whereby it is possible to mount and remove the battery pack 20 to and from the battery mounting portion 18.

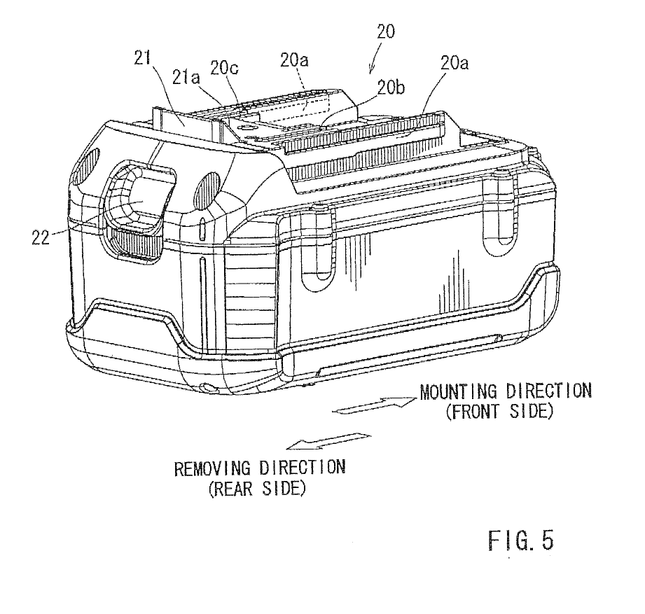

FIG. 5 shows the battery pack 20 in the sate of being removed from the battery mounting portion 18. The battery pack 20 includes therein a 14.4 V rechargeable lithium ion battery, which can be repeatedly used through recharging by a charger that is separately prepared.

Generally speaking, as compared with a nickel hydrogen battery, a lithium ion battery is lighter. For example, a commercially available nickel hydrogen battery with a voltage of 14.4 V and a nominal capacity of 3.3 Ah weighs 1020 g, whereas a commercially available lithium ion battery with a voltage of 14.4 V and a nominal capacity of 3.0 Ah weighs approximately 500 g, which is approximately half the weight of the former. Thus, by using a lithium ion battery as the power source, it is possible to achieve reduction in the weight of the handy cleaner 10 as a whole.

The battery pack 20 has a substantially hexahedron block-like shape and has an upper surface with two terminal grooves 20b and 20c that are elongated in forward and rearward directions and are respectively equipped with a positive terminal and a negative terminal. In correspondence with the terminal grooves 20b and 20c, the battery mounting portion 18 is provided with a positive connection terminal 18b and a negative connection terminal 180. With the positive connection terminal 18b entered the terminal groove 20b, and with the negative connection terminal 18c entered the terminal groove 20c, the battery pack 20 is mounted to the battery mounting portion 18, whereby the battery pack 20 is electrically connected to a power source circuit of the cleaner body 10.

At the rear portion of the battery pack 20, there is provided an engaging claw 21 that can vertically project from and retract into the upper surface of the rear portion. A release button 22 is provided at the rear surface of the battery pack 20. The engaging claw 21 can be downwardly retracted if the user operates the release button 22 with his or her finger to slide it downwards toward a rest position. The engaging claw 21 is urged by a spring toward an engaging position on the upper side of the rest position. The front portion of the engaging claw 21 is provided with an inclined surface 21a for displacement of the engaging claw 21 toward the rest position according to the operation of mounting the battery pack 20.

In correspondence with the engaging claw 21, the rear portion of the battery mounting portion 18 is provided with an engaging recess 18d for engagement with the engaging claw 21. When the engaging claw 21 enters the engaging recess 18d, the displacement of the battery pack 20 toward the removal side (rear side) is restricted. Thus, the battery pack 20 is automatically engaged by the battery mounting portion 18 and is locked in a mounting position relative to the handle 16 of the cleaner body 11. Thus, the engaging claw 21 serves as an engaging device that can automatically engage the battery pack 20 when the battery pack 20 is positioned at the mounting position.

When, in this mounted position, the user manually moves the release button 22 of the battery pack 20 downwards with his or her finger, the engaging claw 21 is displaced together downwards to retreat from the engaging recess 18d. Thus, it is possible to remove the battery pack 20 from the battery mounting portion 18 by sliding it rearwards. Thus, the release button 22 serves as a releasing device that can be manually operated by the user for releasing the engagement of the engaging claw 21 with the cleaner body 11.

As shown in FIGS. 1 and 2, within a range from the front portion of the battery mounting portion 18 to the lower portion of the cleaner body 11, an outer contour of the body housing 14 is gently inclined. As a result, in the state in which the battery pack 20 has been mounted to the battery mounting portion 18, a space S allowing insertion of the user's finger is produced on the front side of the battery pack 20. By inserting the finger into the space S, the user can easily push the battery pack 20 rearwards to remove the same.

According to the handy cleaner 10 of the first embodiment constructed as described above, by slidably moving the battery pack 20 in the forward and rearward directions, the battery pack 20 can be mounted to and removed from the battery mounting portion 18 provided at the lower portion of the handle 16. For mounting the battery pack 20, the battery pack 20 is slid forwards while causing engagement of its engaging protrusions 20a with the right and left guide rail portions 18a. Then, the engaging claw 21 provided at the rear portion is retracted downwards due to the action of the inclined surface 21a. When the battery pack 20 reaches the mounting position, where it is electrically connected to the power source circuit, the engaging claw 21 automatically enters the engaging recess 18d of the battery mounting portion 18. As a result, the displacement of the battery pack 20 in the removing direction is restricted, and the battery pack 20 is locked in the mounting position, where the battery pack 20 extends along the lower surface of the handle 16.

In order to remove the battery pack 20, the user pushes the release button 22 downward with his or her fingertip to cause the engaging claw 21 to retreat from within the engaging recess 18d, and the user then slides the battery pack 20 rearwards.

In the mounting position, the battery pack 20 defines a part of an outer contour of the handy cleaner 10. In other words, the battery pack is partly exposed to the outer side of the handy cleaner 10. There is no cover that is necessary to be opened and closed when mounting and removing the battery pack 20. Therefore, the usability (operability) of the handy cleaner 10 can be improved in terms of the mounting and removing operations of the battery pack 20.

Further, with the handy cleaner 10 of this embodiment, in the state in which the battery pack 20 has been mounted, the space S is produced on the front side of the battery pack 20 to allow insertion of a finger(s) of the user, so that the operation of removing the battery pack 20 can be easily performed. Because the removal of the battery pack 20 can be effected easily by utilizing the space S, it is not necessary to provide any special anti-slip structures, such as protrusions, on the right and left side portions of the battery pack 20.

Further, due to the engagement of the engaging claw 21 with the engaging recess 18d, it is possible to reliably hold the battery pack 20 in the mounting position. In addition, by pushing down the release button 22, the removal can be easily effected, which also helps to improve the handling property of the battery pack 20.

Although the battery pack 20 may be reduced in weight approximately by half as compared with a battery pack using a nickel hydrogen battery, the battery pack 20 still has a relatively large weight as compared with the other components provided on the side of the cleaner body 11. However, since the battery pack 20 is mounted directly below the handle 16 that is grasped by the user, the user can carry about the handy cleaner 10 without experiencing substantial load applied by the weight of the battery pack 20 in comparison with the case in which the battery pack is attached to the front end portion of the cleaner body 11.

Further, in the above embodiment, the battery pack 20 is not assembled within the body housing 14 but is mounted to the cleaner body 11 in a partly exposed state without need of a cover. Therefore, the same battery pack can be shared by different handy cleaners or by different electric tools regardless of the sizes as long as battery mounting portions of the tools have the same dimensional relationship with each other with regard to the construction relating to mounting of the battery pack. Therefore, it is possible to realize a standardized battery pack.

Further, by using an electric motor or a transformation circuit suited to a wide range of voltage, it is possible to use battery packs of different voltages, such as those having a rating voltages of 12 V, 14.4 V and 18 V.

### Second Embodiment

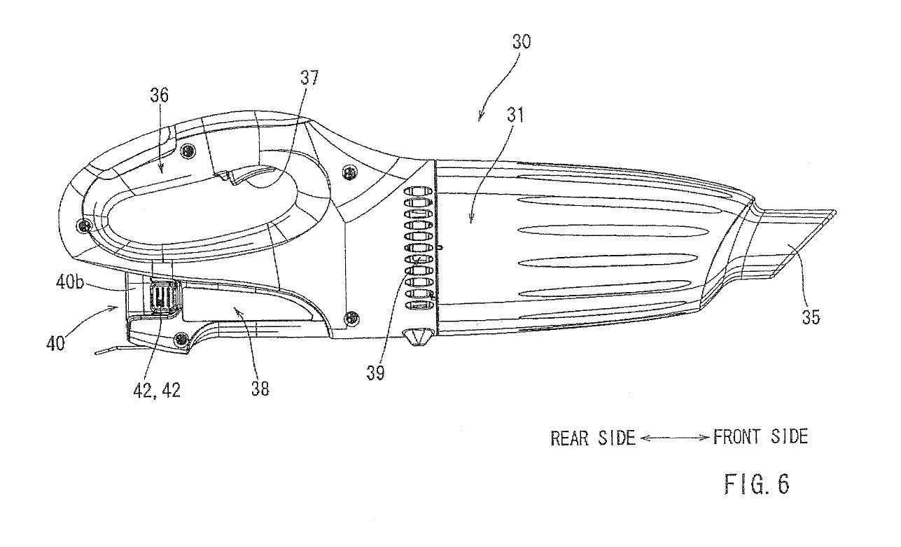

Next, FIGS. 6 through 9 show the handy cleaner 30 according to a second embodiment of the present invention. Similar to the first embodiment, a cleaner body 31 of the handy cleaner 30 has a body housing 34, in which an electric motor 32 and a suction mechanism 33 operated by the electric motor are accommodated. A dust inlet port 35 is provided at the front portion of the body housing 34.

At the rear portion of the cleaner body 31, there is provided a loop-shaped handle 36 that can be grasped by the user. On the inner peripheral side of the handle 36, there is provided a switch lever 37 that can be pulled by a finger(s) of the user. When the switch lever 37 is pulled, the electric motor 32 is started, so that dust or the like can be drawn from the dust inlet port 35.

In the right and left side portions of the body housing 34 around the suction mechanism 33, there are provided exhaust ports 39. Exhaust gas resulting from the dust drawing operation can be blown out from the body housing 34 in the radial direction via the exhaust ports 39.

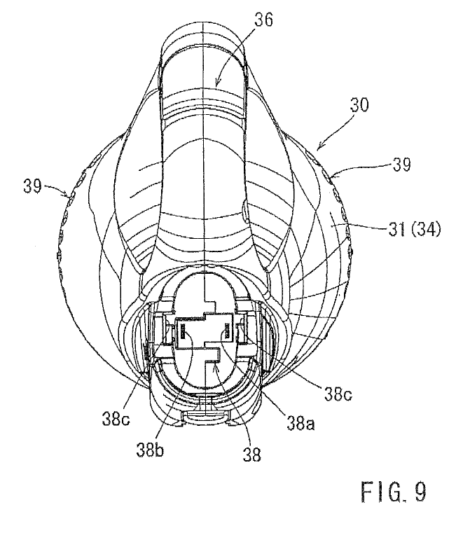

A battery mounting portion 38 is provided on the lower side of the handle 36. In this embodiment, the battery mounting portion 38 has a tubular configuration and has a rear opening as shown in FIG. 9. A positive connection terminal 38a and a negative connection terminal 38b are arranged at the innermost portion (bottom portion) of the battery mounting portion 38. The insertion and removal of the battery pack 40 into and from the battery mounting portion 38 is effected from the rear side in order to mount and remove the battery pack 40 to and from the cleaner body 31. As the battery pack 40 is inserted into the battery mounting portion 38, the connection terminals 38a and 38b of the battery mounting portion 38 are inserted into corresponding terminal holes (not shown) of the battery pack 40 having terminals for connection with the connection terminals 38a and 38b, whereby the battery pack 40 is electrically connected to the power source circuit of the cleaner body 31.

The battery pack 40 of the second embodiment includes a 7.2 V lithium ion battery and may be smaller in size than the battery pack 20 of the first embodiment. The battery pack 40 includes a main body portion 40a having an elliptical sectional configuration, and a head portion 40b having a diameter slightly larger than the main body portion 40a and disposed on the rear side of the main body portion 40b. The main body portion 40a has four battery cells disposed therein.

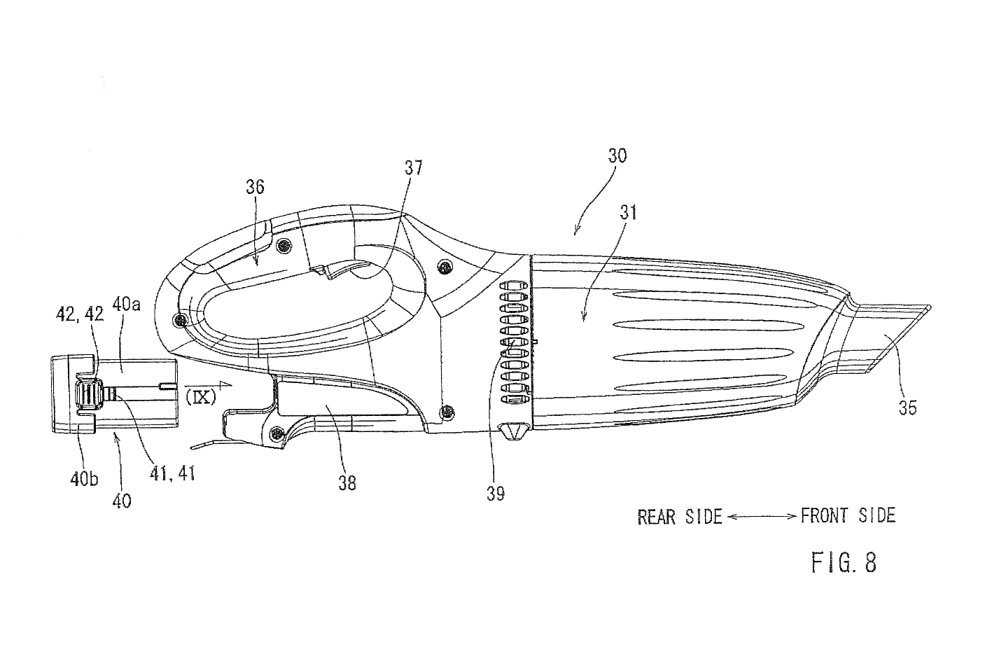

As shown in FIG. 8, on each of the right and left side portions of the head portion 40b of the battery pack 40, an engaging claw 41 and a release button 42 capable of moving the engaging claw 41 for disengagement of the same are provided. As shown in FIG. 9, in correspondence with the engaging claws 41, a pair of right and left engaging protrusions 38c are provided on the inner side of the inlet portion of the battery mounting portion 38. The engaging claws 41 engage the corresponding engaging protrusions 38c only when the battery pack 40 moves in the removing direction from the mounting position. The engaging claws 41 are elastically retracted to allow movement of the battery pack 40 toward the mounting position when the battery pack 40 is moved in the mounting direction. Thus, when the battery pack 40 is inserted into the battery mounting portion 38, the right and left engaging claws 41 are respectively engaged with the engaging protrusions 38c provided on the side of the battery mounting portion 38, whereby the battery pack 40 is engaged and locked in the mounting position.

In state that the battery pack 40 is locked in the mounting position, if the right and left release buttons 42 are pushed with fingers of the user in such a manner that they are pushed from opposite sides, the engagement of the engaging, claws 41 with the engaging protrusions 38c is released, so that it is possible to remove the battery pack 40 by pulling it rearwards out of the battery mounting portion 38. FIG. 8 shows the state in which the battery pack 40 has been removed.

With the handy cleaner 30 of the second embodiment constructed as described above, the battery pack 40 can be mounted and removed through insertion into and removal from the battery mounting portion 38 of the handy cleaner 30. In the mounted state, mainly the head portion 40b of the battery pack 40 is exposed to the outside and defines a part of an outer contour of the handy cleaner 30. It is not necessary to perform the opening and closing operations of a cover when mounting and removing the battery pack 40, whereby it is possible to improve the handling property of the handy cleaner 30.

Further, since the battery pack 40, which may occupy a relatively large weight percentage of the handy cleaner 30, is mounted to the lower portion of the handle 36, it is possible to improve the weight balance, for example, when the handy cleaner 30 is carried about.

### Third Embodiment

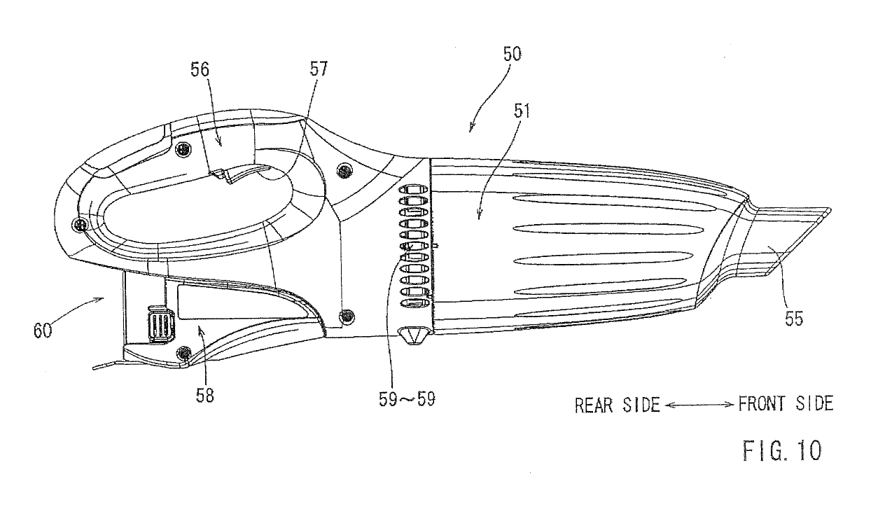

FIGS. 10 through 13 show the handy cleaner 50 according to the third embodiment of the present invention. The battery pack 60 of the handy cleaner 50 of this embodiment is different from that of the second embodiment described above. The cleaner body 51 has a construction similar to the cleaner body 31 of the second embodiment. Thus, a dust inlet port 55 is provided at the forward end portion of the cleaner body 51, and a loop-shaped handle 56 capable of being grasped by the user is provided on the rear portion of a body housing 54. A switch lover 57 can be pulled by a finger(s) of the user and is provided on the inner peripheral side of the handle 56. Further, in the right and left side portions of the body housing 54 substantially at the center in the longitudinal direction (forward and rearward directions), there are provided exhaust ports 59.

A battery mounting portion 58 is provided on the handle 56 and extends along the lower portion of the handle 56. Similar to the second embodiment, the battery mounting portion 58 is formed to have a tubular configuration with, a rear opening. A positive connection terminal 58a and a negative connection terminal 58b are arranged at the innermost portion (bottom portion) of the battery mounting portion 58. By inserting and removing the battery pack 60 into and from the battery mounting portion 58 from the rear side, it is possible to mount and remove the battery pack 60 to and from the cleaner body 51.

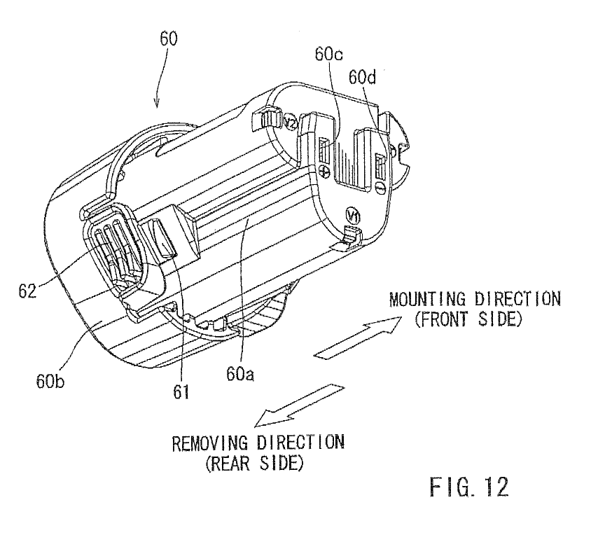

As shown in FIG. 12, the battery pack 60 of the third embodiment includes a main body portion 60a having a substantially triangular sectional configuration, and a head portion 60b having a diameter slightly larger than the main body portion 60a and disposed on the rear side thereof. The main body portion 60a has three battery cells disposed therein. Positive and negative terminal holes 60c and 60d having terminals disposed therein are provided at the front end surface of the main body portion 60a. When the main body portion 60a is inserted into the battery mounting portion 58, the connection terminals 58a and 58b are inserted into the corresponding terminal holes 60c and 60d, whereby the battery pack 60 is electrically connected to the power source circuit of the cleaner body 51.

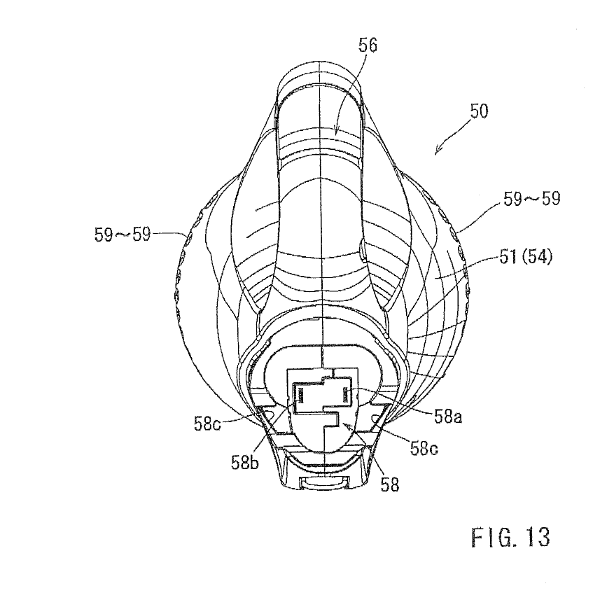

An engaging claw 61 and a release button 62 capable of moving the engaging claw 61 for disengagement of the same are provided on each of the right and left side portions of the head portion 60b. As shown in FIG. 13, in correspondence with the engaging claws 61, a pair of right and left engaging protrusions 58c are provided on the inner side of the inlet portion of the battery mounting portion 58. The engaging claws 61 engage with the engaging protrusions 58c only when the battery pack 60 moves in the removing direction from the mounting position. The engaging claws 61 are elastically retracted to allow movement of the battery pack 60 to the mounting position when the battery pack 60 is moved in the mounting direction. Thus, as the battery pack 60 is inserted into the battery mounting portion 58, the right and left engaging claws 61 are respectively engaged with the engaging protrusions 58c provided on the side of the battery mounting portion 58, whereby the battery pack 60 is engaged and locked in the mounting position.

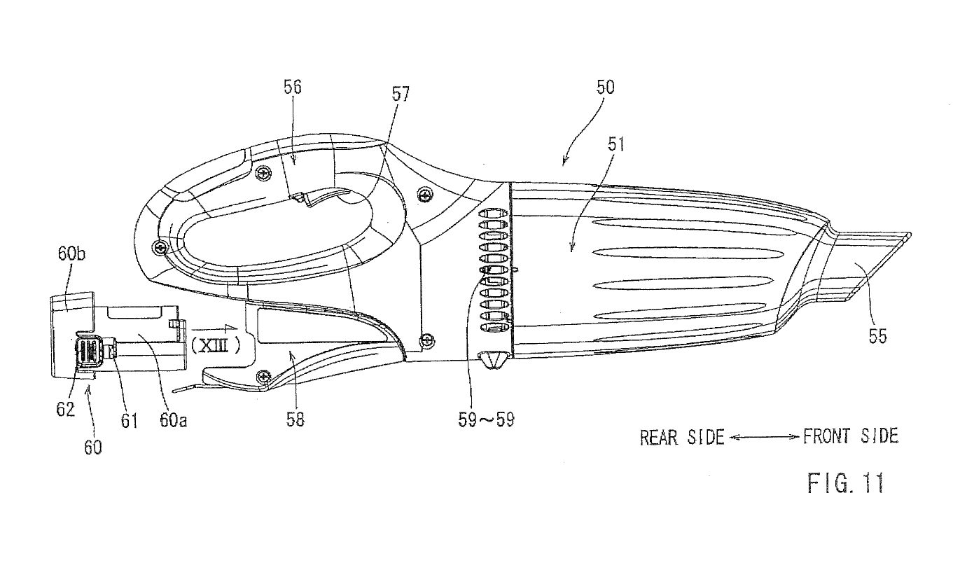

When, in this mounted state, the user pushes the right and left release buttons 62 with fingers in such a manner that they are pushed from opposite sides, the engagement state of the engaging claws 61 with the engaging protrusions 58cc is released, so that it is possible to remove the battery pack 60 by pulling it rearwards out of the battery mounting portion 58. FIG. 11 shows the state in which the battery pack 60 has been removed.

Also with the handy cleaner 50 of the third embodiment, the battery pack 60 can be mounted and removed through insertion into and removal from the battery mounting portion 58 without need of the operations for opening and closing a cover. Therefore, the operability and the handling property of the handy cleaner 50 are improved.

### Fourth Embodiment

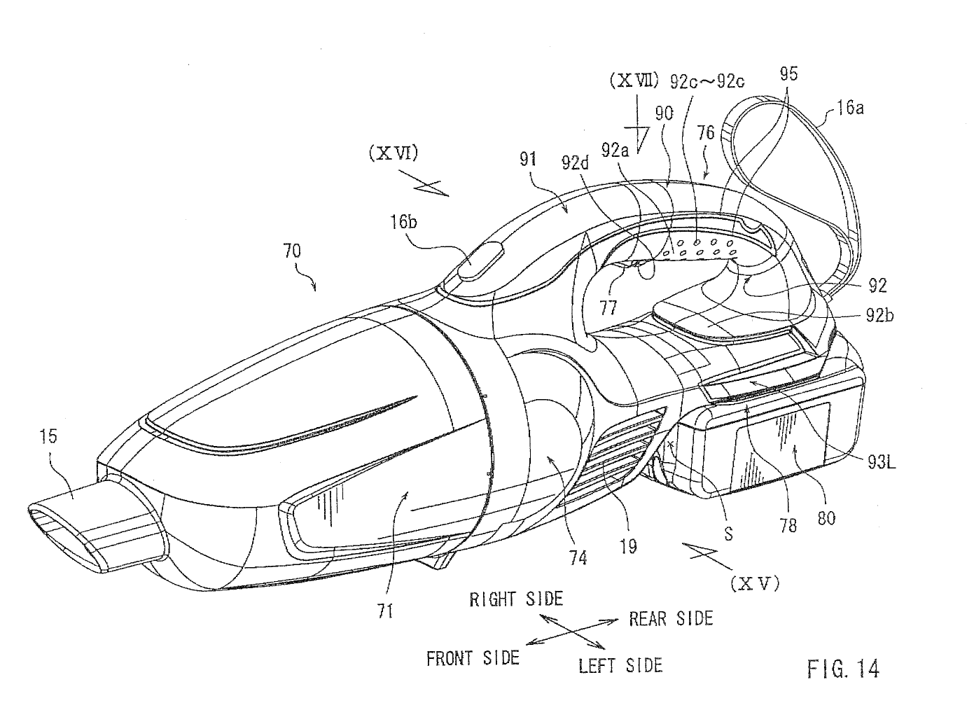

Next, the fourth embodiment of the present invention will be described with reference to FIGS. 14 through 21. This embodiment is a modification of the first embodiment, and members that are similar to those of the first embodiment are labeled with the same reference numerals, and the description of these members will not be repeated.

A battery mounting portion 78 of this embodiment extends along the lower portion of a handle 76 and protrudes in the right and left directions therefrom. The battery pack 80 can be mounted to the battery mounting portion 78.

The handle 76 protrudes upwards in a loop-shape from the upper portion of the battery mounting portion 78. More specifically, the upper portion of the battery mounting portion 78 constitutes a part of the loop shape of the handle 76. The loop shape of the handle 76 of this embodiment is flattened to have an elliptical configuration having a longitudinal axis in the forward and rearward directions.

The rear portion of the handle 76 rises from the upper surface of the rear portion of the battery mounting portion 78. The front portion of the handle 76 extends upward from substantially the central portion with respect to the forward and rearward directions of the upper surface of a main body case 74. On the inner peripheral side of the handle 76, there is secured a space that is large enough to allow the user to insert his or her fingers for grasping the handle 76 and to pull a switch lever 77 with his or her index finger F2.

A cover 90 mainly serving as a slip preventing member is attached to the handle 76. The cover 90 is formed of elastomer resin, which may be attached to the surface of the handle 76 by an insertion molding process with the handle 76 inserted into a mold for molding the cover 90. However, It is also possible to attach the cover 90 to the handle 76 by using any other means, such as adhesive and a fixing device using screws.

The cover 90 includes an upper surface portion 91 covering the upper surface of the handle 76, an inner peripheral portion 92 covering the inner peripheral surface of the handle 76, and protruding portions 93R and 93L coveting the right and left side portions of the battery mounting portions 78. The upper surface portion 91, the inner peripheral portion 92, and the right and left protruding portions 93R and 93L are connected together at the rear portion of the handle 76. Thus, the rear portion of the handle 76 is substantially entirely covered with the cover 90.

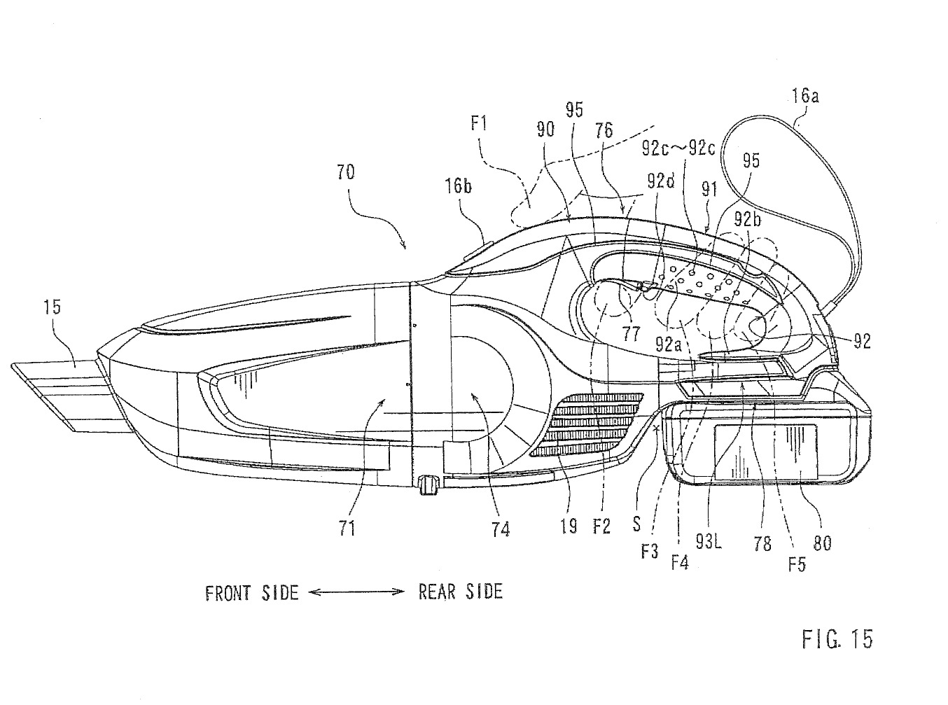

The upper surface portion 91 is attached to extend over the entire longitudinal length of the handle 76. Thus, the front portion of the upper surface of the handle 76 around the light 16 is also covered with the upper surface portion 91. As shown in FIG. 15, if the user grasps the handle 76 with for example, his right hand (indicated by chain double-dashed lines), mainly the palm of the hand is pressed against the upper surface portion 91. Further, as shown in FIG. 15, in the case that the user grasps the handle 76 while extending his or her thumb F1 forwards, the thumb F1 is also pressed against the upper surface portion 91. Since the upper surface portion 91 is formed of elastomer resin, the palm and the fingertips of the user may be prevented from slipping and they snugly fit with the handle 76, thus making it easier for the user to grasp the handle 76.

The inner peripheral portion 92 is attached to cover substantially half the inner periphery of the rear portion of the handle 76 in the circumferential direction. The inner peripheral portion 92 includes a top portion 92a covering the upper side of the inner periphery of the handle 76 and a bottom portion 92b situated on the lower side and covering a part of the upper surface of the battery mounting portion 78, if the user grasps the handle 76 as shown in FIG. 15, his or her fingertips may be pressed against the top portion 92a and may be prevented from slipping on the top portion 92a, while the backs of the fingers being directed toward the bottom portion 92b. In particular, in this embodiment, the top portion 92a is provided with a large number of hemispherical small protrusions 92c, so that the slip preventing function of the top portion 92a is further enhanced.

Further, the top portion 92a is attached to cover a broad range from the rear portion to the front portion of the inner periphery of the handle 76 and to also cover a range around the switch lever 77. Thus, in the case that the user pulls the switch lever 77 with the index finger F2 of the hand grasping the handle, it is possible to also provide the slip preventing function, allowing the handle to fit snugly with the hand. In addition, the top portion 92a is integrally provided with an anti-slip protrusion 92d that protrudes from a position on the rear side of the switch lever 77. Due to the anti-slip protrusion 92d, the index finger F2 can be prevented from slipping when the user maintains the pulling state of the switch lever 77. Further, due to the anti-slip protrusion 92d, it is possible to prevent erroneous operation of the switch lever 77.

Further, as shown in FIG. 15, the inner peripheral portion 92 of the cover 90 is attached to the rear portion of the inner periphery of the handle 76, and therefore, a portion proximal to the base of the little finger F5 of the hand is pressed against the inner peripheral portion 92. Thus, in particular when the user carries about the handy cleaner 70 by grasping the handle 76, with the handy cleaner 70 facing downwards, the portion proximal to the base of the little finger F5 of the hand is snugly pressed against the inner peripheral portion 92. A comfortable grasping feeling of the user is ensured also in this respect.

The right and left protruding portions 93R and 93L extend along the right and left side portions of the battery mounting portion 78, respectively. Therefore, when the bandy cleaner 70 is placed on a desk or the like with the handy cleaner 70 oriented sideways in the right or left direction, the right and left protruding portion 93R or 93L can prevent the desk or the like from being damaged by the handy cleaner 70. Further, during the operations of sliding the battery pack 80 along the battery mounting portion 78 for mounting and removing the battery pack 80, the user can grasp the battery mounting portion 78 with, for example, his or her left hand and can hold the right and left side portions of the battery mounting portion 78 in such a manner that the right and left side portions are held from opposite sides. Therefore, the right and left protruding portions 93R and 93L can serve as anti-slip members, thereby making it possible to easily perform the mounting and removing operations of the battery pack 80, while the cleaner body 71 being reliably fixed in position.

A groove 95 having a width of approximately between 1 mm to 1.5 mm and a depth of approximately between 0.5 mm to 0.8 mm is provided in the periphery of the cover 90. In this embodiment, the groove 95 extends along the entire periphery of the upper surface portion 91, the inner peripheral portion 92, and the right and left protruding portions 93R and 93L (i.e., along the entire periphery of the cover 90). In particular, a part of the groove 95 extending along the upper surface portion 91 and its part extending along the top portion 92a serve to weakly catch the fingertips, thereby providing an anti-slip function.

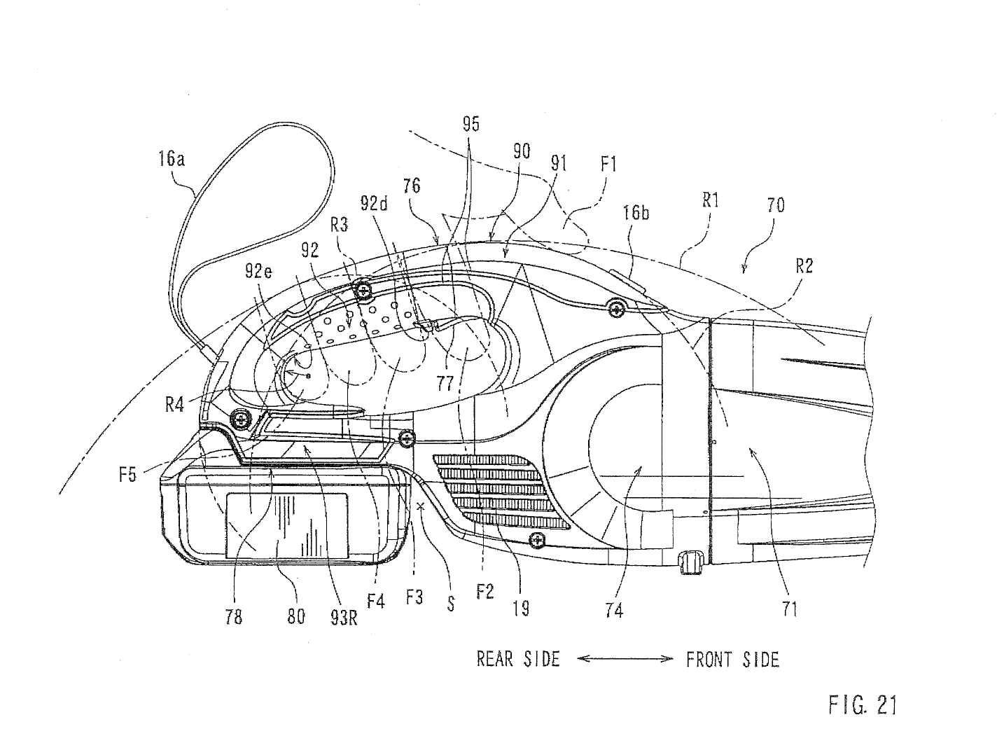

FIG. 21 shows the details of the handle 76. The upper surface of the handle 76 of this embodiment is formed as a curved surface gently curved in the forward and rearward directions. This curved configuration may be appropriately determined taking into consideration, of a grip feeling (holding feeling) by the palm of the hand of the user who grasps the handle. In this embodiment, the central portion of the upper surface of the handle 76 has a configuration of an arc having a radius of curvature R1 of about 207 mm. The front portion of the upper surface has a configuration of an arc having a radius of curvature R2 of about 96 mm. The rear portion of the upper surface has a configuration of an arc having a radius of curvature R3 of about 73 mm. These three different arcs having the radii of curvature R, R2, and R3 are smoothly connected with each other in the forward and rearward directions, thereby providing a feeling of snugly fitting with the palm.

In particular, in this embodiment, the elastomer cover 90 (more specifically, the upper surface portion 91) is attached to the upper surface of the handle 76, so that the palm of the user can be pressed more snugly against the handle 76. Therefore, a feeling in holding the handle 76 can be improved. Regarding the radii of curvature R1, R2, and R3, they can be suitably set as long as the holding property of the upper surface portion is not seriously impaired. For example, each of the above numerical values of the radii of curvature R1, R2, and R3 may be changed within a range around between −10% and +10%. Thus, R1 may be approximately between 180 mm and 230 mm, R2 may be approximately between 85 mm and 110 mm, and R3 may be approximately between 60 mm and 85 mm.

Further, the handle 76 is gradually reduced in thickness in the rearward direction. In this embodiment, the dimension in girth (i.e., the circumferential length) of the handle 76 at a position proximal to the index finger F2 of the hand of the user who grasps the handle 76 (i.e., the side of the front portion of the handle 76) is set to be about 110 mm, and the dimension in girth at a position proximal to the little finger F5 (i.e., the side of the rear portion of the handle 76) is set to be about 95 mm. Therefore, the ratio between them (i.e., the ratio of the thickness on the side of the little finger to the thickness on the side of the index finger) is set to be about 0.86. This ratio can also be changed within a range of around between −10% and +10% (i.e., approximately between 0.75 and 0.95).

In this way, the portion the handle on the side of the index finger F2 of the hand grasping the handle 76 is thicker than the portion of the handle on the side of the little finger F5. Therefore, the user can firmly grasp the handle 76 with his or her five fingers F1 through F5 inclusive of the little finger F5, whereby it is possible to further improve the grip feeling and the holding property of the handle 76.

Further, the rear end portion of the inner peripheral side of the handle 76 is also configured to improve its feeling in holding. A little finger holding portion 92e having a configuration of a semicircular arc is provided at the rear end of the inner periphery of the handle 76. In this embodiment, the semicircular arc of the little finger holding portion 92e has a radius of curvature R4 of about 11 mm. The radius of curvature R4 may be set in accordance with the thickness of the base of the little finger F5 of the grasping hand and may be changed within a range of approximately between 8 mm and 15 mm.

The gripping property and the feeling in holding the handle 76 can be further improved, in particular when the user grasps the handle 76 and firmly presses a portion of the hand proximal to the base of the little finger F5 against the little finger holding portion 92e. In this embodiment, the elastomer cover 90 (in particular, the inner peripheral portion 92) is attached to the little finger holding portion 92e. Therefore, it is possible to grasp the handle 76, with the portion of the hand proximal to the base of the little finger F5 being snugly pressed against the inner peripheral portion 92 of the cover 90. Hence, it is possible to improve the gripping property and the feeling in holding the handle 76 also in this respect.

Further, in this embodiment, mainly the size in the forward and rearward directions of the inner peripheral portion 92 of the cover 90 is appropriately set such that the portion of the hand proximal to the base of the little finger F5 is always held at the little finger holding portion 92e and that the pulling operation of the switch lever 77, etc. can be effected in this state.

The battery pack 80 can be mounted when it is moved to slide forward along the battery mounting portion 78. Conversely, the battery pack 80 can be removed when it is moved to slide rearwards along the battery mounting portion 78. During these operations, the right and left protruding portions 93R and 93L can serve as anti-slip members.

Also in this embodiment, if the user downwardly moves the release button 22 with his or her fingertip and slides the battery pack 80 backwards, it is possible to remove the battery pack 80 from the battery mounting portion 78. In this case, the user can grasp the battery mounting portion 78 with one hand to hold it in such a manner that the battery mounting portion 78 is held from the opposite sides (the right and left sides), while the right and left protruding portions 93R and 93L of the cover 90 serving as anti-slip members. Therefore, it is possible to reliably keep the cleaner body 71 in position.

With the handy cleaner 70 of this embodiment constructed as described above, the loop-shaped handle 76 enables the handy cleaner 70 to be easy handled both during use and during conveyance, thus enabling the handy cleaner 70 to fully exert its function and convenience.

Further, since the elastomer cover 90 is attached to the surface of the loop-shaped handle 76, it is possible to endow the handle 76 with a sufficient anti-slip function, and to enable the user to use the handy cleaner 70 while enjoying the snug, comfortable feeling in grasping the handle, whereby it is possible to enhance the commercial value (added value) of the handy cleaner 70.

Further, slipping of mainly the palm of the grasping hand is prevented by the upper surface portion 91 of the cover 90, and slipping of the fingers is prevented by the top portion 92a of the inner peripheral portion 92, while a snug feeling peculiar to elastomer resin can be given to the palm and the fingertips. Therefore, it is possible to further enhance the ease of grasping the handle 76 (grasping feeling) and to eventually enhance the added value of the handy cleaner 70.

The upper surface portion 91 of the cover 90 is attached to the entire range from the front portion to the rear portion of the handle 76. Therefore, even in the case that the user grasps the handle 76, with his or her thumb F1 extended forwards, the anti-slip function can be exerted as the thumb F1 is pressed against the upper surface portion 91.

Further, the anti-slip small protrusions 92c are provided at the top portion 92a of the inner peripheral portion 92 to further improve the anti-slip function. In addition, the protrusion 92d is provided on the rear side of the switch lever 77. Therefore, it is possible to endow the handy cleaner 70 with an anti-slip function and a pulling operation maintaining function at the time of pulling by, for example, the index finger F2.

Further, the elastomer cover 90 (more specifically, the inner peripheral portion 92) is attached to the rear portion of the inner peripheral side of the handle 76. Therefore, when the handle 76 is grasped for carrying about the handy cleaner 70 in the downwardly facing state by applying the little finger F5 to the rear portion of the inner peripheral side of the handle 76, it is possible to provide a snug contact feeling to the little finger F5, to which the weight of the cleaner is applied, while preventing slippage of the little finger F5. Hence, it is possible to enhance the comfortable feeling of the handle 76 in using the bandy cleaner 70.

Further, since the protruding portions 93R and 93L of the cover 90 are attached to the right and left side portions of the battery mounting portion 78, they can be used as damage prevention guards for the other portions or as shock absorbing members when the handy cleaner 70 is accidentally fallen. During the mounting and removing operations of the battery pack 80, the battery mounting portion 78 can be grasped in such a manner that it is held from opposite sides via the protruding portions 93R and 93L, whereby the protruding portions 93R and 93L can serve as anti-slip members, so that the cleaner 70 can be easily held in position. As a result, convenience at the time of replacement of the battery pack 80 can be improved.

The upper surface portion 91, the top portion 92a, the bottom portion 92b, and the right and left protruding portions 93R and 93L of the cover 90 are branched off from the rear portion of the handle 76 to respectively extend forwards. Therefore, it is possible to endow the handle 76 with a sharp appearance, which also helps to enhance the commercial value of the handy cleaner 70.

Further, the central portion of the upper surface of the handle 76 is formed as an arc shaped surface having a large radius of curvature R1, so that the handle 76 can snugly fit into the palm of the grasping hand, whereby ease of grasping (functionality) of the handle 76 is further improved. Further, the elastomer cover 90 (in particular, the upper surface portion 91) is attached to the upper surface portion of the handle 76, and the upper surface portion 91 is formed as an arc shaped surface to correspond to the shape of the palm and can be easily grasped. Therefore, little fatigue may result even if the user grasps the handle 76 for a long period of time, so that the functionality of the handy cleaner 70 can be improved.

Further, a portion of the handle 76 on the side of its rear portion (the side of the little finger F5) is thinner than a portion on the side of the front portion (the side of the index finger F2). As a result, it is possible to firmly grasp the handle 76 with the five fingers F1 through F5 inclusive of the little finger F5, whereby it is possible to further enhance the functionality of the handy cleaner 70. In particular, since the portion on the side of the little finger F5 is thinner, the user can get a sufficient gripping feel also with the little finger F5, whereby it is possible to enhance the sense of safety holding of the handle 76 during use and during conveyance.

Further, the base of the little finger F5 inserted into the inner periphery of the loop of the handle 76 can be applied to the little finger holding portion 92e having a semicircular arc shape so as to be firmly held in position. Therefore, the user can feel stability of the grasping state. In particular, in the case of this embodiment, the portion of the hand proximal to the base of the little finger F5 is snugly pressed against the elastomer cover 90 (in particular, the inner peripheral portion 92) attached to the little finger holding portion 92e. Therefore, it is possible to improve the holding property of the handle 76.

In this way, the handle 76 of this embodiment can snugly fit into the palm of the user grasping the handle 76 and the thickness of the handle 76 becomes thinner in a direction from the front portion toward the rear portion. Therefore, it is possible to firmly grasp the handle 76 with the five fingers F1 through F5 inclusive of the little finger F5. In addition, the portion of the hand proximal to the base of the little finger F5 can be applied to the little finger holding portion 92e having a configuration of a semicircular arc, so that the user can grasp the handle with a still more satisfactory holding feeling, whereby it is possible to further enhance the functionality and convenience of the handle 76 and eventually of the handy cleaner 70, so that the added value of the handy cleaner as a commercial product can be further enhanced.

The fourth embodiment described above can be modified in various ways. For example, the size of the upper surface portion 91 of the cover 90 can be reduced by configuring such that the upper surface portion 91 is attached to only a limited area of the handle, which may contact with the palm of the grasping hand. Further, the bottom portion 92b of the inner peripheral portion 92 or the right and left protruding portions 93R and 93L may be omitted.

Further, although the upper surface portion 91, the top portion 92a and the bottom portion 92b of the inner peripheral portion 92, and the right and left protruding portions 93R and 93L are connected together at the rear portion of the handle 76 in the fourth embodiment, they can be separated from each other.

In the case of the fourth embodiment, it is possible to employ a nickel cadmium battery or any other type of battery instead of the lithium ion battery.

Further, the cover 90 of the fourth embodiment can be applied to the loop-shaped handle 36 of the handy cleaner 30 of the second embodiment and also to the loop-shaped handle 56 of the handy cleaner 50 of the third embodiment. It is also possible to apply the cover 90 to a loop-shaped handle of a handy cleaner that has a motor driven by an AC power source and does not require a battery pack.

This invention claims:

1. A handy cleaner comprising:
a cleaner body including a handle capable of being grasped by a user during use of the handy cleaner; and
a battery pack serving as a power source and including a lithium-ion battery;
wherein the battery pack has an engaging device and a releasing device;
wherein the engaging device is capable of engaging the cleaner body when the battery pack is positioned at a mounting position relative to the cleaner body; and
wherein the releasing device is coupled to the engaging device and is operable to release engagement of the engaging device with the cleaner body.

2. The handy cleaner as in claim 1, wherein:
the engaging device includes an engaging claw provided on the battery pack;
the releasing device includes a release button movably attached to the battery pack;
the engaging claw is capable of being engaged with and disengaged from the cleaner body;
the release button is operable to move the engaging claw for disengagement from the cleaner body; and
the release button is exposed to the outer side of the handy cleaner when the battery pack is in the mounting position.

3. The handy cleaner as in claim 1, wherein:
the handle is disposed at a rear portion of the cleaner body; and
the battery pack is attached to the handle so as to extend along a lower portion of the handle.

4. The handy cleaner as in claim 3, wherein the lower portion of the handle includes a pair of guide rails, and the battery pack can be slid along the pair of guide rails to move to the mounting position and to move away from the mounting position.

5. The handy cleaner as in claim 1, wherein a space allowing insertion of a finger of a user is provided between the cleaner body and a front portion of the battery pack in the mounting position.

6. The handy cleaner as in claim 1, wherein when the battery pack is in the mounting position, at least a part of an outer surface of the battery pack is directly exposed to the outside of the handy cleaner; and the at least a part of the outer surface can be grasped by a hand of a user for moving the battery pack from the mounting position and removing the battery pack from the cleaner body.

7. The handy cleaner as in claim 6, wherein when the battery pack is in the mounting position, the at least a part of the outer surface of the battery pack is substantially flush with an outer surface of the cleaner body.

8. The handy cleaner as in claim 1, wherein:
the handle has a loop-shape; and
a cover made of elastomer resin is attached to the handle.

9. The handy cleaner as in claim 8, wherein the cover includes an upper portion covering an upper surface of the handle.

10. The handy cleaner as in claim 9, wherein the upper portion of the cover extends along the entire length of the handle in a longitudinal direction of the handle.

11. The handy cleaner as in claim 10, wherein the cover has an inner circumferential portion covering an inner circumference of the handle including a semi-perimeter region of a rear portion of the inner circumference.

12. The handy cleaner as in claim 11, further comprising a switch lever disposed at a front portion with respect to the longitudinal direction, of the inner circumference of the handle, wherein the switch lever is operable for starting the handy cleaner, and wherein the inner circumferential portion extends to a position proximal to the switch lever.

13. The handy cleaner as in claim 8, further comprising a battery mounting portion provided on the handle for mounting the battery pack, wherein the battery mounting portion extends along a lower portion of the handle and protrudes from the handle in right and left directions along a widthwise direction of the handle, and wherein the cover includes protruding portions capable of covering right and left portions of the battery mounting portion.

14. The handy cleaner as in claim 8, wherein an upper portion of the handle has an upper surface configured as a curved surface gently curved along the longitudinal direction to correspond to the configuration of a palm of a hand of a user who grasps the handle.

15. The handy cleaner as in claim 14, wherein the curved surface includes a front portion, a rear portion and a central portion extending in series between the front portion and the rear portion along the longitudinal direction, wherein the central portion has a radius of curvature of 207 mm, the front portion has a radius of curvature of 96 mm, and the rear portion has a radius of curvature of 73 mm.

16. The handy cleaner as in claim 8, wherein the handle has a thickness gradually decreasing from a front side portion toward a rear side portion in the longitudinal direction, wherein a ratio of the thickness of the rear side portion to the thickness of the front side portion is set to be 0.86.

17. The handy cleaner as in claim 16, wherein a rear end portion of the inner circumference of the handle has a little finger holding surface having a semi-circular arc-shaped configuration of a radius of curvature of 11 mm.

18. The handy cleaner as in claim 1, wherein:
the handle has a loop shape;
an upper portion of the handle has an upper surface configured as a curved surface gently curved in a longitudinal direction of the handle to correspond to the configuration of a palm of a hand of a user who grasps the handle;
wherein the handle has a thickness gradually decreasing from a front side portion toward a rear side portion along the longitudinal direction,
wherein a rear end portion of an inner circumference of the handle has a little finger holding surface having a semi-circular arc-shaped configuration corresponding to the configuration of a base portion of a little finger of the hand of the user.

19. A handy cleaner comprising:
a cleaner body including a handle capable of being grasped by a user during use of the handy cleaner; and
a battery pack serving as a power source and including a lithium-ion battery;
wherein when the battery pack is mounted to the cleaner body, at least a part of an outer surface of the battery pack is directly exposed to the outside of the cleaner body; and the at least a part of the outer surface can be grasped by a hand of a user for removing the battery pack from the cleaner body.

20. A handy cleaner comprising:
a cleaner body including a loop-shaped handle capable of being grasped by a user; and
a cover made of elastomer resin and attached to the handle.

21. A handy cleaner comprising:
a cleaner body including a loop-shaped handle capable of being grasped by a hand of a user;
wherein an upper portion of the handle has an upper surface configured as a curved surface gently curved in a longitudinal direction of the handle to correspond to the configuration of a palm of the hand of the user;
wherein the handle has a thickness gradually decreasing from a front side portion toward a rear side portion along the longitudinal direction,
wherein a rear end portion of an inner circumference of the handle has a little finger holding surface having a semi-circular arc-shaped configuration corresponding to the configuration of a base portion of a little finger of the hand of the user.
